(19) United States
(12) Patent Application Publication
(10) Pub. No.: US 2003/0162075 A1
(43) Pub. Date: Aug. 28, 2003

(54) FUEL CELL MANIFOLD BASE

(76) Inventor: Brian Gorbell, Calgary (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 10/248,905

(22) Filed: Feb. 28, 2003

Related U.S. Application Data
(60) Provisional application No. 60/319,129, filed on Feb. 28, 2002.

(51) Int. Cl. H01M 8/24; H01M 8/12; H01M 8/04; H01M 8/10

(52) U.S. Cl. 429/38; 429/32; 429/26; 429/30; 429/34

(57) ABSTRACT

A fuel cell stack manifold base mounts planar fuel cell stacks in a horizontally opposed manner.

### CROSS REFERENCE TO RELATED APPLICATIONS

This application claims the priority of U.S. provisional patent application No. 60/319,129 filed on Feb. 28, 2002.

### BACKGROUND OF INVENTION

This invention relates to a fuel cell stack manifold for connecting at least two solid oxide fuel cell stacks.

In a solid oxide fuel cell, oxidant and fuel are electrochemically reacted without burning to directly produce electricity. The reactants are supplied to the cell through manifolds and channels that direct reactants to the appropriate sides of a solid ceramic membrane that acts as an electrolyte.

All fuel cells require fuel and oxidant to be supplied to opposite sides of the ceramic membrane, and therefore a manifold and its associated piping is required to separately bring the fuel and oxidant gasses from their supply to the fuel cell stack. It is also beneficial to preheat the gasses. Prior art fuel cells have used complex manifolds and large coils of tubing to preheat the air incoming to the fuel cell. For certain applications, such as automotive primary or auxiliary power generation, space is at a premium and large and bulky manifolding and heat exchangers cannot be accommodated.

Therefore, there is a need in the art for a compact system of mounting, manifolding and heat exchange for solid oxide fuel cell stacks.

### SUMMARY OF INVENTION

The present invention is directed to fuel cell stack manifold and base for horizontally opposed planar solid oxide fuel stacks. In one aspect of the invention, the invention comprises a manifold for connecting at least two planar solid oxide fuel cell stacks comprising:

(a)an enclosure including two opposing substantially parallel surfaces for mounting the at least two stacks, such that the fuel cell stacks are positioned on opposing sides of the manifold, each surface defining a fuel inlet opening, a fuel exhaust opening, an air inlet opening, and an air exhaust opening and each surface having a flat sealing surface that surrounds the four openings; and

(b)wherein the enclosure comprises a fuel inlet port in sealed fluid communication with the fuel inlet openings, a fuel exhaust port in sealed fluid communication with the fuel exhaust openings, an air inlet port in sealed fluid communication with the air inlet openings, and an air exhaust port in sealed fluid communication with the air exhaust ports.

The enclosure is preferably rectangular in vertical and horizontal cross-section and includes three internal substantially horizontal baffles. The resulting four internal chambers correspond with the intake and exhaust ports for fuel and air as well as the intake and exhaust openings connecting the fuel cell stacks.

### BRIEF DESCRIPTION OF DRAWINGS

The invention will now be described by way of an exemplary embodiment with reference to the accompanying simplified, diagrammatic, not-to-scale drawings. In the drawings:

FIG. 1 shows a side view of the present invention.

FIG. 2 shows an end view of the present invention.

FIG. 3 shows a top view of the present invention.

FIG. 4 shows a cross section thorough the present invention.

### DETAILED DESCRIPTION

The present invention provides for a fuel cell stack manifold for connecting at least two solid oxide fuel cell stacks in a horizontally opposed manner. When describing the present invention, the following terms have the following meanings, unless indicated otherwise. All terms not defined herein have their common art-recognized meanings. The manifold has been described as having a “boxer” configuration, in reference to the horizontally opposed internal combustion engine, known as a boxer engine and most famously utilized by Porsche™.

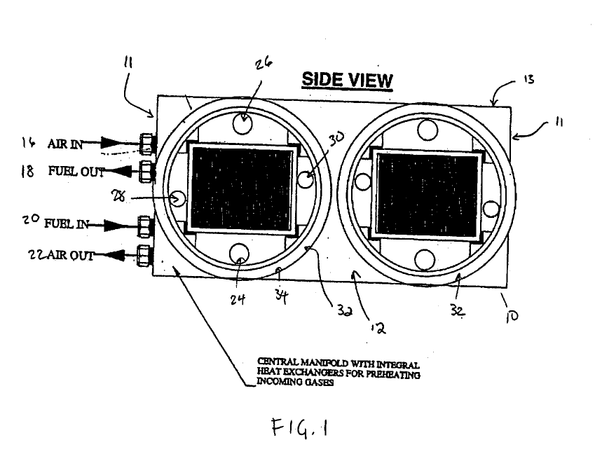

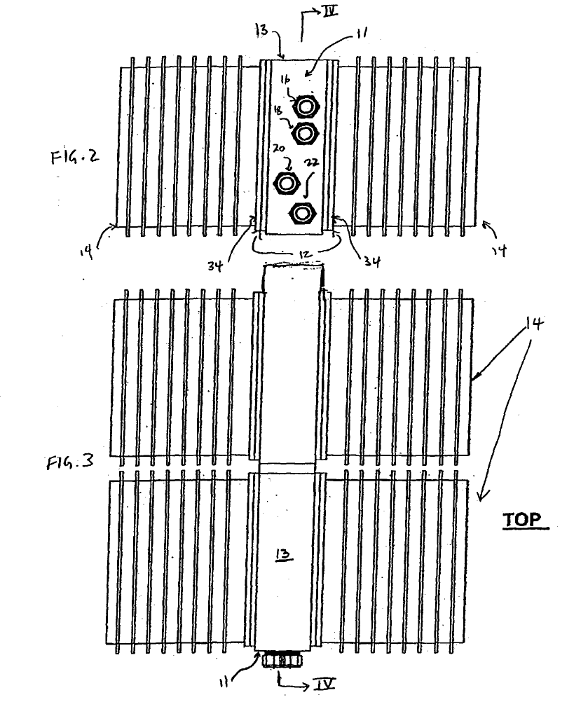

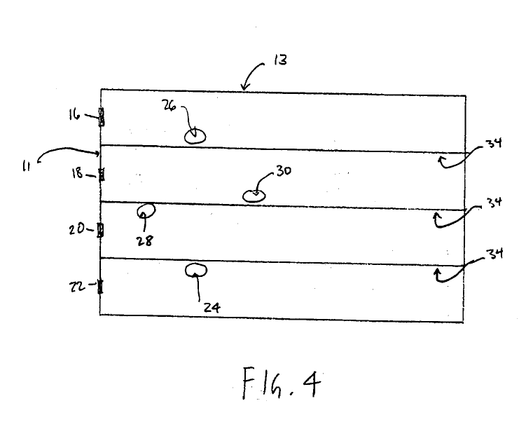

A manifold (10) is shown in FIG. 1 for mounting solid oxide fuel cell stacks. In one embodiment, the manifold (10) comprises a substantially rectangular enclosure which includes substantially flat and parallel opposing lateral walls (12), end walls (11) and a top wall (13) perpendicular to the lateral and end walls (1, 12). Solid oxide fuel cell stacks (14) are mounted to a mounting footprint on the outside surfaces of the lateral walls (12). The mounting footprint consists of mounting flanges (34) and sealing surfaces (32). The stacks (14) may be mounted using conventional studs or bolts (not shown) as well known in the art.

The manifold (10) has a plurality of ports for the passage of fuel and oxidant gasses into and out of the manifold (10) and stacks (14). Port (16) admits air or other oxidant gasses into the manifold and port (22) allows the spent oxidant gas to exit the manifold. Port (20) admits fuel gas into the manifold and port (18) is for the removal of spent fuel gasses from the manifold. All of the preceding ports are equipped with coupling or joining means such that piping can be attached to the ports in a gas tight manner for conducting the gasses to other parts of the fuel cell system as necessary. Conventional coupling or joining means are well known in the art.

The interior of the manifold (10) is divided into four compartments by three internal baffles (34) as seen in FIG. 4. Each compartment is fluid tight and the only openings are those openings which connect to the fuel cell stacks. As seen in FIG. 1, each stack mounting footprint includes an opening for each of the fuel and air intake and exhaust gas streams (24, 26, 28, 30). Once gasses are admitted to the interior chambers of the fuel cell base (10), they are directed to appropriate openings in the lateral surfaces (12). Opening (26) is used for directing air into the fuel cell stack and opening (24) is for exhausting the consumed air out of the fuel cell stack. Fuel gasses are admitted to the stack through opening (28), while the spent gasses are exhausted from the stack through opening (30). The openings described hereinabove are all contained within the mounting footprint perimeter defined by the sealing surface (32), and as such are isolated from the atmosphere to preserve the integrity of the sealing system from the gas supply to the final exhaust to atmosphere. The four openings described above are repeated for each fuel cell stack.

The ports (16 22) are illustrated in one embodiment as being vertically aligned and located on one end wall (11) of the manifold. One skilled in the art will realize that the location of the ports may be varied to accommodate different physical configurations. For example the ports may be provided between the two stack footprints shown in FIG. 1. Alternatively, the ports may be located on the top wall of the manifold, however, that configuration would require internal ducting beyond the horizontal baffles to maintain gas separation of the four gas streams.

In one embodiment, the baffles (34) are rectangular sheets of material, similar to and compatible with the other parts of the manifold. The edges of the baffles (34) are joined to the interior surfaces of the lateral walls (12) and end walls (11) in a gas tight manner, typically by welding. Baffles (34) divide the interior chamber of the manifold into 4 separate gas tight compartments, each of which has a port for admitting gasses, as described above. The chambers correspond with the openings described hereinabove, such that the gas can pass from the port through the opening and into the fuel cell stack. The chambers and ports are arranged such that the inlet and exhaust chambers are adjacent, and thus function as counterflow heat exchangers to preheat the incoming gasses and recover heat from the exhaust gasses. This improves the thermal efficiency of the system, and prevents thermal shocking of the stack from cold gasses entering a hot stack. The baffles should preferably be made from a thermally conductive material to facilitate such heat transfer. Alternatively, the baffles may have heat exchange fins, or other heat exchange means, projecting into the adjacent chambers. In another alternative, the baffles may be corrugated to increase surface area for heat exchange.

In a further embodiment, an additional module can be added to the end of the manifold (10) which contains an afterburner. This allows the waste fuel and air streams to be combined and burned within the module. This will allow a greater amount of preheat of the incoming fuel and oxidant gasses, as well as reducing the emissions of unburnt fuel.

The configuration of the present embodiment represents an advantage over the prior art, since the manifold is compact, yet still allows for preheating and heat exchange between the inlet and outlet flows of the gasses, and can also accommodate an afterburner. In addition, the manifold allows individual access to each stack, and allows any stack to be changed in the case of failure without disturbing any of the other fuel cell stacks. As a further benefit, the fuel and oxidant ports, and their associated ducting can be made more compact that a manifold that siameses two or more fuel cell stacks together. Since the manifold is only supplying one fuel cell stack at a time, the ports can be optimally sized to ensure an adequate gas supply to each fuel cell stack without starvation. In a multiple fuel cell stack arrangement, the total amount of gas that can be supplied to each stack is limited by port size in the manifold as well as the manifold size within the fuel cell stack itself. In some cases, fuel starvation can occur within the fuel cell stacks due to inadequate manifold size within the fuel cell stacks themselves.

As will be apparent to those skilled in the art, various modifications, adaptations and variations of the foregoing specific disclosure can be made without departing from the scope of the invention claimed herein.

1. A manifold for connecting at least two planar solid oxide fuel cell stacks comprising:
(a)an enclosure including two opposing substantially parallel surfaces for mounting the at least two stacks, such that the fuel cell stacks are positioned on opposing sides of the manifold, each surface defining a fuel inlet opening, a fuel exhaust opening, an air inlet opening, and an air exhaust opening and each surface having a flat sealing surface that surrounds the four openings; and
(b)wherein the enclosure comprises a fuel inlet port in sealed fluid communication with the fuel inlet openings, a fuel exhaust port in sealed fluid communication with the fuel exhaust openings, an air inlet port in sealed fluid communication with the air inlet openings, and an air exhaust port in sealed fluid communication with the air exhaust ports.

2. The fuel cell manifold of claim 1, wherein a vertical cross section of the manifold has a vertical dimension and a horizontal dimension, and wherein the vertical dimension is larger than the horizontal dimension.

3. The fuel cell manifold of claim 2, wherein the vertical cross section is quadrilateral.

4. The fuel cell manifold of claim 1, wherein the manifold connects 4 fuel cell stacks, configured as two opposing pairs.

5. The fuel cell manifold of claim 1 wherein the enclosure comprises three substantially horizontal internal dividers, creating a fuel intake chamber, a fuel exhaust chamber, an air intake chamber and an air exhaust chamber, wherein each of the four chambers are layered horizontally within the enclosure.

6. The fuel cell manifold of claim 5 wherein heat exchange occurs between the exhaust chambers and the intake chambers to preheat incoming fuel and air.

7. The fuel cell manifold of claim 6 wherein said internal dividers comprise heat exchange fins or corrugations.

8. The fuel cell manifold of claim 1 further comprising an afterburner module for mixing and burning fuel exhaust gases with air exhaust gases and using the generated heat to preheat air and fuel.
